(19) United States
(12) Patent Application Publication
(10) Pub. No.: US 2017/0071003 A1
(43) Pub. Date: Mar. 9, 2017

(54) METHOD, NETWORK NODE AND COMPUTER PROGRAM

(71) Applicant: TELEFONAKTIEBOLAGET LM ERICSSON (PUBL), Stockholm (SE)

(72) Inventors: Bengt LINDOFF, Bjarred (SE); Fredrik GUNNARSSON, Linkoping (SE); Bo HAGERMAN, Tyreso (SE)

(73) Assignee: Telefonaktiebolaget L M Ericsson (publ), Stockholm (SE)

(21) Appl. No.: 15/308,393

(22) PCT Filed: Feb. 11, 2015
(86) PCT No.: PCT/EP2015/052864

§ 371 Date: Nov. 2, 2016

(51) Int. Cl. H04W 72/04; H04W 76/04

(52) U.S. Cl. CPC H04W 72/0486; H04W 76/048

(57) ABSTRACT

A method of a network node of a cellular communication network is disclosed. The method comprises determining transmission behaviour of stations associated with the network node. The method includes, for at least one of the stations associated with the network node, determining whether the transmission behaviour of the station indicates intermittent transmission activity of the station, and if the intermittent transmission activity indicated by the transmission behaviour of the station is in a first state being an intermittent activity state, applying an action plan for that station such that radio resource consumption by that station is reduced. A network node and a computer program are also disclosed.

### TECHNICAL FIELD

The present invention generally relates to a method of a network node of a cellular communication network, such a network node, and a computer program for implementing the method. In particular, the present invention relates to determining transmission behaviour of stations associated with the network node, and taking actions such that radio resource consumption is reduced.

### BACKGROUND

Traffic behaviour has changed since the introduction of cellular communication systems. Traditionally, the traffic behaviour was mainly based on a circuit switched call which lasted for at least a fraction of a minute and mostly a couple of minutes. With the increasing use of different programs and applications in terminals the traffic behaviour has changed into relatively short bursts of data traffic. This gives rise to some problems for network design. One of them is how long a terminal should be in active mode before returning to idle mode. The transfers between active and idle modes generate overhead signalling in the air interface, such as for example authentication procedures, which may cause capacity reduction or shortage of network resources.

FIG. 1 illustrates transitions between active mode 100 and idle mode 102. FIG. 1 also illustrates (dashed lines) a traditional approach for reducing the transitions, i.e. to let the terminals be in active mode and use active mode discontinuous reception. DRX, 101 for keeping power consumption low. This approach however requires the system, i.e. the nodes of the cellular communication system, to keep a lot of terminals in active mode 100 when many terminals are connected to a base station, and this in turn has impact on internal administration in the system, such as for addresses, memory handling, detection, etc. Thus, additional load is put on the system which causes increased need of resources or reduced capacity for given resources.

It is therefore a desire to provide an alternative approach for handling hi traffic behaviour.

### SUMMARY

The invention is based on the insight that the problem of bursty traffic behaviour caused by intermittent transmission activity of connected terminals causes a problem when load on a network node is high, or causes a problem by making it high, and that terminals causing the overhead traffic consume more capacity than justified by their payload traffic. The inventors have found that by identifying such a situation and identifying such terminals, the network may be enabled to deal with the situation. A number of ways of dealing with the situation have also been invented.

According to a first aspect, there is provided a method of a network node of a cellular communication network. The method comprises determining transmission behaviour of stations associated with the network node. The method determines, for at least one of the stations associated with the network node, whether the transmission behaviour of the station indicates intermittent transmission activity of the station. If the intermittent transmission activity indicated by the transmission behaviour of the station is in a first state being an intermittent activity state, the method applies an action plan for that station such that radio resources allocated to that station are reduced.

The transmission behaviour may comprise any of a transition rate between active and idle states of the station, a number of times entering a discontinuous reception, DRX, state, and a metric based on an analysis of inflow and outflow of data buffers, which data buffers are arranged for storage of data before transmitting the data to respective stations.

The determining transmission behaviour of the stations may comprise registering in a memory each station associated with the network node as either being in the first state or a second state, wherein the first state may comprise the transmission behaviour of the station indicating intermittent activity above a second threshold and the second state may comprise the transmission behaviour of the station indicating intermittent activity below a third threshold, and the determining whether the transmission behaviour of the station indicates intermittent activity of the station may comprise accessing the memory.

The second threshold may be higher than the third threshold such that a hysteresis is formed. Alternatively, the second threshold and the third threshold may be equal.

The action plan for a station may comprise any of handing over that station to another radio access technology, operating that station in an unlicensed spectrum using the present radio access technology, and restricting connection for that station.

The action plan for a station may comprise enabling a device-to-device, D2D, communication mode for that station, being a first station, and configuring at least another station, being a set of stations, also being in the first mode for D2D communication mode and verify whether in D2D vicinity to the first station, and if verified as being in D2D vicinity to the first station, configuring connection of the stations of the set of stations by D2D communication via the first station. The method may comprise periodically, for the first station and the stations of the set of stations, changing which of the stations to be the first station such that fair power consumption distribution among the stations is achieved.

The action plan for a station may comprise signalling to a charging unit of the cellular communication network to increase charging for that station, and transmitting a notification to that station about the charging change.

The method may comprise determining signalling load of the network node, and if the signalling load is above a first threshold, enabling the action plan for at least one of the stations associated with the network node and being in the first state. The determining of the signalling load of the network node may comprise determining the used amount of available addresses or memory for keeping track of the associated stations, wherein the first threshold may correspond to a percentage of the used amount to the available addresses or memory.

The network node may be a node of a core network of the cellular communication network and the determining of transmission behaviour of stations associated with the network node may comprise receiving, from a base station associated with a station, transmission behaviour of the station associated with a previous time, and estimating current transmission behaviour of the station, wherein the determining of the transmission behaviour of the station may be performed in consideration of the received transmission behaviour and the estimated current transmission behaviour. The action plan may include utilizing the determined transmission behaviour for connection or resource management in the network node.

The network node may be a node of a core network of the cellular communication network and the method may comprise receiving, at a first time instant, transmission behaviour information associated with a station from a base station of the cellular communication network, storing in a memory the received transmission behaviour information with an identifier associated to the station, receiving from the base station, at a second time instant, an indication that the station has established a connection with the base station, retrieving, from the memory, transmission behaviour related to an identifier associated to the station, and sending the retrieved transmission behaviour information to the base station, such that connection or resource management is facilitated in the base station.

According to a second aspect, there is provided a network node of a cellular communication network. The network node comprises a transmission behaviour determinator mechanism arranged to determine a transmission behaviour of stations associated with the network node, and a controller arranged to, for at least one of the stations associated with the network node, determine whether the transmission behaviour of the station indicates intermittent transmission activity of the station, and if the intermittent transmission activity indicated by the transmission behaviour of the station is in a first state being an intermittent activity state, to apply an action plan for that station such that radio resources allocated to that station are reduced.

The transmission behaviour may comprises any of a transition rate between active and idle states of the station, a number of times entering a discontinuous reception, DRX, state, and a metric based on an analysis of inflow and outflow of data buffers, which data buffers are arranged for storage of data before transmitting the data to respective stations.

The transmission behaviour determinator mechanism may be arranged to register, in a memory, each station associated with the network node as either being in the first state or a second state, wherein the first state may comprise the transmission behaviour of the station indicating intermittent activity above a second threshold and the second state may comprise the transmission behaviour of the station indicating intermittent activity below a third threshold, and the controller may be arranged to determine whether the transmission behaviour of the station indicates intermittent activity of the station by accessing the memory.

The second threshold may be higher than the third threshold such that a hysteresis is formed. Alternatively, the second threshold and the third threshold may be equal.

To apply the action plan for a station may include that the controller is arranged to perform any of to initiate a hand over of that station to another radio access technology, to initiate operating that station in an unlicensed spectrum using the present radio access technology, and to configure restriction of connection for that station.

The action plan for a station may include that the controller is arranged to enable a device-to-device, D2D, communication mode for that station, being a first station, configure at least another station, being a set of stations, also being in the first mode for D2D communication mode and verify whether in D2D vicinity to the first station, and if verified as being in D2D vicinity to the first station, to configure connection of the stations of the set of stations by D2D communication via the first station. The controller may be arranged to periodically, for the first station and the stations of the set of stations, configure change of which of the stations to be the first station such that fair power consumption distribution among the stations is achieved.

The action plan for a station may include that the controller is arranged to configure signalling to a charging unit of the cellular communication network about an increase of charging for that station, and to initiate transmission of a notification to that station about the charging change.

The network node may comprise a signalling load determinator mechanism arranged to determine a signalling load of the network node, wherein the controller may be arranged to determine whether the signalling load is above a first threshold, and if so, to enable the action plan for at least one of the stations associated with the network node and being in the first state. The signalling load determinator mechanism may be arranged to determine the signalling load of the network node by determining the used amount of available addresses or memory for keeping track of the associated stations, wherein the first threshold may correspond to a percentage of the used amount to the available addresses or memory. The network node may be a node of a core network of the cellular communication network, and the transmission behaviour determinator mechanism may be arranged to determine the transmission behaviour of stations associated with the network node by receiving, from a base station associated with a station, transmission behaviour of the station associated with a previous time, and estimating current transmission behaviour of the station, wherein the determination of the transmission behaviour of the station may be performed in consideration of the received transmission behaviour and the estimated current transmission behaviour. To apply the action plan may include utilizing the determined transmission behaviour for connection or resource management in the network node.

The network node may be a node of a core network of the cellular communication network, and the controller may be arranged to receive, at a first time instant, transmission behaviour information associated with a station from a base station of the cellular communication network, store in a memory the received transmission behaviour information with an identifier associated to the station, receive from the base station, at a second time instant, an indication that the station has established a connection with the base station, retrieve, from the memory, transmission behaviour related to an identifier associated to the station, and send the retrieved transmission behaviour information to the base station, such that connection or resource management is facilitated in the base station.

According to a third aspect, there is provided a computer program comprising instructions which, when executed on a processor of a network node, causes the network node to perform the method according to the first aspect.

Other objectives, features and advantages of the present invention will appear from the following detailed disclosure, from the attached dependent claims as well as from the drawings. Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings.

FIG. 1 illustrates transitions between active mode and idle mode.

FIG. 2 illustrates transitions between an intermittent transmission activity state and a second state.

FIG. 3 is a flow chart schematically illustrating a method according to an embodiment.

FIG. 4 is a block diagram schematically illustrating a communication device.

FIG. 5 schematically illustrates a computer-readable medium and a processing device.

FIG. 6 illustrates a part of a cellular communication network.

FIG. 7 illustrates examples of applied action plans in context of a part of a cellular communication network.

### DETAILED DESCRIPTION

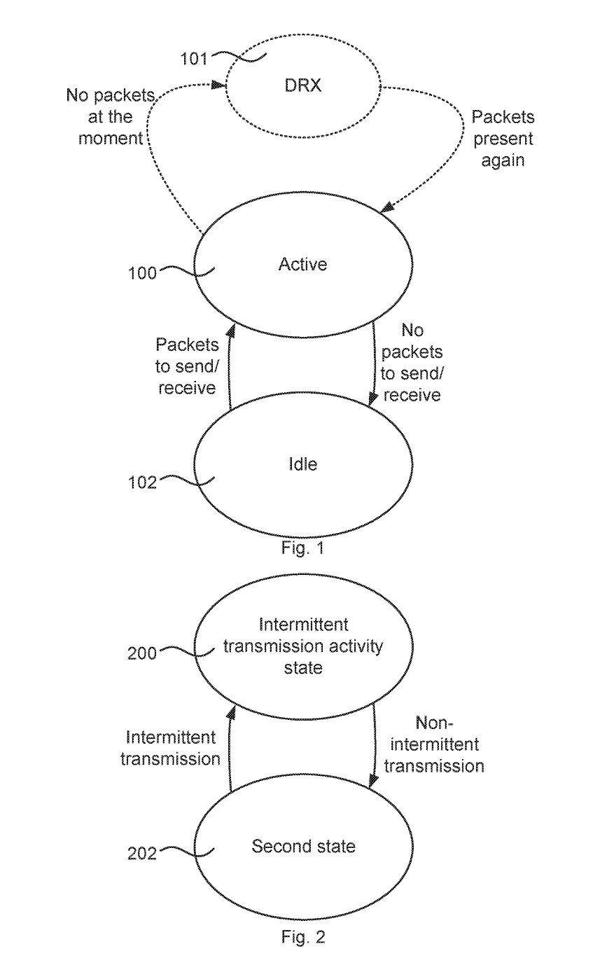

FIG. 1 illustrates transitions between active mode 100 and idle mode 102. By for example observing the transitions between active and idle modes 100, 102, the signalling behaviour of each station may be determined. From this, a state may be assigned to each station indicating whether the station has intermittent transmission activity behaviour. Since the behaviour may change over time, each station will transition between an intermittent transmission activity state 200 and a second state 202 as illustrated in FIG. 2. The states 200, 202 may additionally or alternatively be determined based on other metrics or information such as statistics or prior knowledge about the use of the station (e.g. machine-to-machine communication, use of application(s), pure data communication subscription, etc.) where the use inherently implies intermittent transmission activity. The term station is here used since the station may take different roles in a modern cellular communication network such as terminal or cluster head, and the term may be substituted by User Equipment (UE), mobile communication device, terminal, sensor, modem, smart phone etc. In addition to this, the term station may also be referring to a logical entity rather than a physical entity. That is, the logical entity may be defined by a user, a subscription, e.g. defined by a subscription identity module (SIM), or other identification such as internet protocol (IP) address, medium access control (MAC) address, international mobile subscription identifier (IMSI), etc.

Determination of state by observing transitions between the active and idle modes 100, 102 may be determined based on a transition rate between the active and idle modes 100, 102. The transition rate may for example be the number of transitions during a windowed time period.

If the approach is to let the stations be in active mode and use active mode DRX 101, e.g. when network load is low, this may also be taken into account by including the number of times entering DRX 101. It may also involve analysis of one or more data buffers. Such data buffers reside in the base station for temporary storage of data before transmitting it to the station, but similar buffers are used in other network nodes as well. By analysing the inflow and outflow to the buffers, the buffer length, and their variability, one can determine the state. For example, the determination of state can be based on the variations of data inflow, or the variations of the buffer length, or even the buffer outflow.

A station may for example be assigned the intermittent transmission activity state 200 when the transition rate is above a threshold. The station may be assigned to be in the second state 202 when the transition rate is below the threshold. Alternatively, a hysteresis for assigning the states 200, 202 is desired wherein one threshold is used for assigning the intermittent transmission activity state 200 when present in the second state and another threshold is used for assigning the second state 202 when present in the intermittent transmission activity state 200. A hysteresis may avoid a station toggling between the states 200, 202 too frequently. Such toggling may jeopardize the benefits of actions taken for stations being in the intermittent transmission activity state.

The observing of the transmission behaviour may include registering e.g. metrics, parameters or events, or the determined state related to the transmission behaviour for each of at least a subset of stations associated with the network node in a memory. Further details about keeping track of the transmission behaviour will be presented below, e.g. about how to keep track when a station changes its association with network nodes.

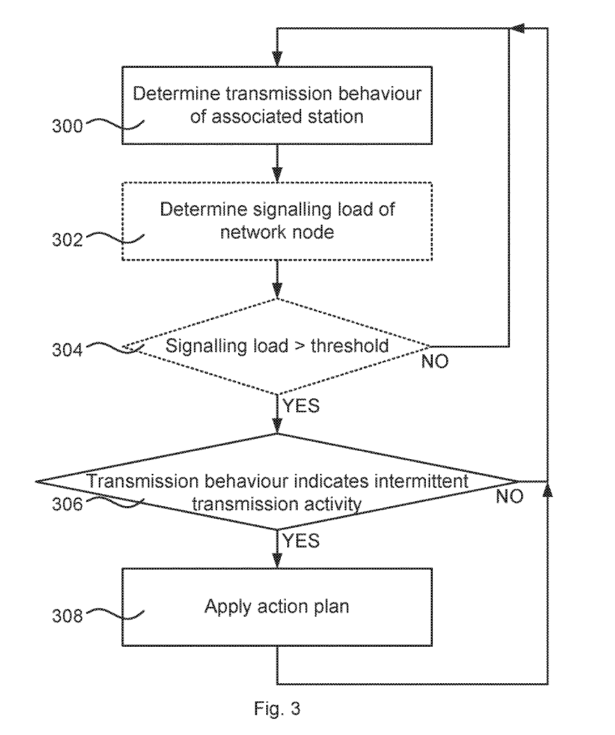

Considering the above demonstrated approaches for determining whether a station is in a state of intermittent transmission activity or in another state, and the fact that stations with bursty traffic behaviour is mainly a problem when the network is heavy loaded, and according to some embodiments it is suggested an approach for applying an action plan for stations with bursty traffic only when considered needed, i.e. when it is determined that the network load is high. On the other hand, the action plan may be applied for stations with bursty traffic behaviour to avoid that the network becomes heavy loaded, which is suggested according to some embodiments. FIG. 3 is a flow chart schematically illustrating a method according to an embodiment. The method is performed in a network node of a cellular communication system. The network node may for example be a base station or a network node in a core network, for example a Mobility Management Entity, MIME, or be a functional aggregation thereof. The method comprises determining 300 transmission behaviour of an associated station, i.e. a station that is connected to or camping at a base station associated with the network node or a base station being the network node. The determining 300 is performed according to any of the ways demonstrated above. The determining may include the analysis demonstrated with reference to step 306 below, wherein stations having an intermittent transmission activity may be stored or indicated in a list stored in a memory. For example, each station may be associated with an information element about its configuration and status, in E-UTRAN referred to as a UE context.

According to some embodiments, signalling load of the network node may optionally be determined 302. Here, signalling load is to be construed as anything affecting resource constraints for handling the associated stations, such as signalling overhead and internal administration in the system, e.g. for addresses, memory handling, detection, etc., for interactions between the stations and the network node such as information feedback, control signalling, time synchronization signalling, etc.

It is optionally checked 304 whether the signalling load is above or below a threshold, wherein if the signalling load is not above the threshold, it is not considered that any actions are necessary and the method returns to do the determining steps 300, 302 at a later instant, e.g. periodically or based on any occurred event. In the flow chart of FIG. 3, the embodiment comprising considering the signalling load is illustrated as determining the signalling load and checking it against a threshold prior to analysis of intermittent transmission activity. However, the analyses of signalling load and intermittent transmission activity may be performed in any order, or in parallel. The analysis for step 304 may be made in a real time process, or it may be evaluated when performing the step 304. One example is observing a metric based on the number of used addresses for associated stations being active or needed to keep track on, and considering the amount of used addresses in relation to available addresses or memory space for the addresses. Here, the signalling load may be considered above the threshold if for example a percentage or quota thereof is above a certain value. For example, the threshold may be that 90% of available addresses and/or memory for keeping track of the stations are used and the signalling load may be above the threshold when a larger amount of the available addresses or memory space is used. If the signalling load is above the threshold, the method may for some embodiments perform, for each station of at least a subset of the stations associated with the network node, a check 306 whether the station in question has a transmission behaviour that indicates intermittent transmission activity.

The method performs a check 306 whether the station in question has a transmission behaviour that indicates intermittent transmission activity. This may be made as demonstrated above by assigning a state for the stations, which may be made in a real time process, or it may be evaluated when performing the step 306. If the station is considered to have signalling behaviour which indicates intermittent transmission activity, e.g. being in the intermittent transmission activity state as demonstrated above, an action plan is applied 308 for that station to reduce allocated resources of the network node. Examples on action plans are demonstrated below, and further actions may be feasible depending on the configuration and abilities of the network. However, the important feature is to come to the conclusion whether anything needs to be done or if any actions are not necessary and instead may degrade experienced performance of the network. As may be recognized from some of the examples of action plans below, there may also be an economic or administrative benefit of not performing some of the actions by the operator of the cellular communication network when not absolutely necessary since some of the actions may include less billing opportunities and/or increased costs. The examples on proper determination whether to apply the action plan as demonstrated with reference to FIG. 3 are therefore a great benefit of its own. Further benefits are then provided through the action plans suggested below.

For the sake of easier understanding, the above demonstrated states includes an intermittent transmission activity state and a second state, but the assignment of states may include two or more intermittent transmission activity states which are assigned based on the transmission behaviour of the station, wherein the different intermittent transmission activity states may lead to different action plans. Furthermore, beyond the second state, for which the station is not considered to have an intermittent transmission activity state, there may be a third, fourth, etc. state, for which the station is not considered to have an intermittent transmission activity state, such that a state machine is formed wherein transitions through the non-intermittent transmission activity states may be made based on events and/or metrics before reaching an intermittent transmission activity state. However, for any such embodiment, there is a determination whether the station is in an intermittent activity state or in a non-intermittent activity state.

As demonstrated above, the network node may for example be a base station or a network node in a core network, for example a Mobility Management Entity, MME, or be a functional aggregation thereof, or a gateway designed to handle user plane data traffic. Examples of the latter in E-UTRAN include a serving gateway, a packet gateway, etc. According to an example, the base station receives user classification from a first network node. The base station gathers information, e.g. statistics, data variation/buffer status, etc. associated to the user and combines with the user classification information. Optionally, the base station manages radio resources in consideration of the user classification information. The base station sends the user classification information to a second network node. Here, the first and second network nodes may be idem or different.

The observed and/or stored knowledge including transmission behaviour of stations compiled into information of interest for determining whether a user/station/ID is indicated as having intermittent transmission activity will below be referred to as “user classification information”. The user classification information may be more or less complex.

The first network node may for example be a network node in the core network, and provide the base station with the user classification information as part of a connection establishment message, e.g. for E-UTRAN/EPC case a UE context setup over S1 interface.

The second network node may for example be a network node in the core network. When the connection is released, the base station sends the current user classification information to the second network node. The user classification information may be quantized into different intermittent transmission activity classes, e.g. the states demonstrated above or with further granularity, or may comprise more complex information, e.g. including statistical information.

The first network node may be another base station. The another base station provides the user classification information as part of a handover procedure from the first network node to the base station, i.e. from the former/another base station to the current base station. The information may be signalled in a handover command message, a mobility control information message, etc. The information may be sent via an interface directly from the another base station to the current base station, or the information may be transferred via a different network node, i.e. depending on the structure of the cellular communication network which the skilled person in the art is considered familiar with. For example, the information is sent to the current base station via a core network node such as the MME.

The second network node may be another base station, wherein the current base station sends the user classification information as part of a handover procedure to the another base station. The information may be signalled in a handover command message, a mobility control information message, etc. The information may be sent via an interface directly from the current base station to the another base station, or the information may be transferred via a different network node, e.g. the MIME.

The base station may enrich the user classification information by combining received user classification information with own observed buffer and traffic variation information. The base station may manage radio resources in consideration of the user classification information.

From the perspective of the network node, i.e. as any description in this disclosure unless otherwise stated, the network node receives buffer and traffic variation information from the base station. The information can either be provided regularly or in one or more batches together with a connection release. The base station may send a batch to the network node as a part of the handover procedure to a target base station.

The network node may combine the received buffer and traffic variation information with stored user classification information to determine new user classification information. The network node may store data variation information or buffer information about one or more user sessions, receive data variation information from a base station after a completed session, aggregating historical data variation information with the received data variation information and classifying the user, ID or station based on the aggregated data variation information.

Thus, the distribution of the managing may be that one network node does the whole bit, or that one network node collects the information and sends it to another network node which manages the radio resources. The collected user classification information may be stored in one or another of the network nodes, or be stored in a database outside the network nodes, such as in home subscriber server (HSS) or in home location register (HLR).

According to one example, the network node performing the method demonstrated above may be anode of a core network of the cellular communication network. The core network node receives transmission behaviour of a station from a base station associated with the station. The information may be gained at a first time instant some time ago. The network node further estimates a current transmission behaviour of the station. Thus, the determining of the transmission behaviour of the station is performed by considering the received transmission behaviour, i.e. from a previous time instant, and the estimated current transmission behaviour. The action plan may then include utilizing the determined transmission behaviour for connection and/or resource management in the network node. The actions demonstrated above may be performed by a controller of the network node.

According to one example, the network node performing the method demonstrated above may be anode of a core network of the cellular communication network. The network node receives, at a first time instant, transmission behaviour information associated with a station from a base station of the cellular communication network. The network node then stores the received transmission behaviour information in a memory with an identifier associated to the station. At a second time instant, the network node receives an indication from the base station that the station has established a connection with the base station. The network node then retrieves, transmission behaviour from the memory related to an identifier associated to the station and sends the retrieved transmission behaviour information to the base station. Thereby, connection or resource management may be facilitated in the base station. The actions demonstrated above may be performed by a controller of the network node.

The suggested features above provides for mobility when keeping track of users/stations/IDs and their history of intermittent transmission activity. It may further enable collecting statistics associated with a mobile station for a longer time also when the mobile station connects to different network nodes.

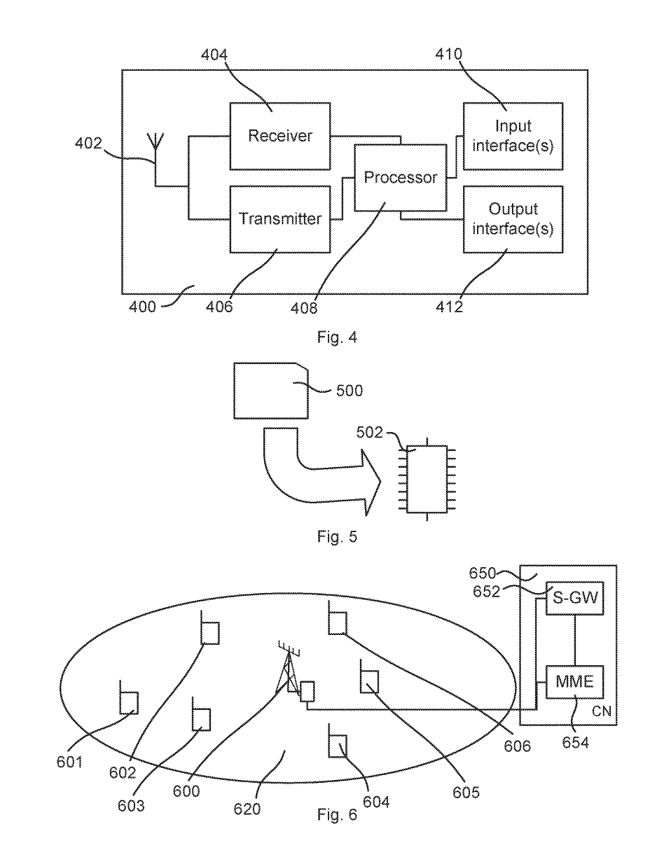

FIG. 4 is a block diagram schematically illustrating a communication device 400 comprising an antenna arrangement 402, e.g. an antenna array, a receiver 404 connected to the antenna arrangement 402, a transmitter 406 connected to the antenna arrangement 402, a processing element 408 which may comprise one or more circuits, one or more input interfaces 410 and one or more output interfaces 412. The interfaces 410, 412 can be user interfaces and/or signal interfaces, e.g. electrical or optical. The communication device 400 may be arranged to operate in a wireless, e.g. cellular communication network. The communication device 400 may be a station as demonstrated above, i.e. terminal, cluster head, UE, mobile communication device, etc. or a network node such as a base station. For the case that the communication device 400 is a base station, the processing element 408 can be arranged for signal processing to enable keeping track of transmission behaviour of associated stations. The processing element may also be involved in controlling the interfaces 410, 412, executing applications, e.g. for signalling operations, etc.

The methods according to the present invention is suitable for implementation with aid of processing means, such as computers and/or processors, especially for the case where the network node collects information about the transmission behaviour of associated stations and is to evaluate whether an action plan is to be applied. Therefore, there is provided computer programs, comprising instructions arranged to cause the processing means, processor, or computer to perform the steps of any of the methods according to any of the embodiments described with reference to FIG. 3. The computer programs preferably comprises program code which is stored on a computer readable medium 500, as illustrated in FIG. 5, which can be loaded and executed by a processing means, processor, or computer 502 to cause it to perform the methods, respectively, according to embodiments of the present invention, preferably as any of the embodiments described with reference to FIG. 3. The computer 502 and computer program product 500 can be arranged to execute the program code sequentially where actions of the any of the methods are performed stepwise, or to execute the program according to a real-time scheme. The processing means, processor, or computer 502 is preferably what normally is referred to as an embedded system. Thus, the depicted computer readable medium 500 and computer 502 in FIG. 5 should be construed to be for illustrative purposes only to provide understanding of the principle, and not to be construed as any direct illustration of the elements.

FIG. 6 illustrates a part of a cellular communication network including a base station 600 operating a cell 620. The base station 600, e.g. an eNodeB, is connected to a core network (CN) 650. Here, the CN 650 is illustrated only with some representative elements for 3GPP LTE, such as a serving gateway (S-GW) 652 and a mobility management entity (MME) 654, but similar elements may be present also for other systems. The S-GW 652 may be arranged to route and forward user data packets, while also acting as a mobility anchor for a user plane during inter-eNodeB handovers and as the anchor for mobility between LTE and other 3GPP technologies. For idle state UEs, the S-GW 652 may terminate downlink data path and trigger paging when downlink data arrives for the UE. It may manage and store UE contexts, e.g. parameters of IP bearer service, network internal routing information, etc. The MME 654 is a control node for LTE access network. The MME 654 is responsible for idle mode UE paging and tagging procedure including retransmissions. The MME 654 is involved in bearer activation/deactivation process and is also responsible for choosing the S-GW 652 for a UE at the initial attach and at time of intra-LTE handover involving CN node relocation. Here, reference is made to the above demonstrated approaches for handling mobility aspects of keeping track of intermittent transmission activity of UEs. The MME 654 is responsible for authenticating the user, by interacting with other elements such as a home subscriber server (HSS). Non Access Stratum (NAS) signalling terminates at the MME 654 and the MME 654 is also responsible for generation and allocation of temporary identities to UEs. The MME 654 checks the authorization of the UE to camp on the service provider's Public Land Mobile Network (PLMN) and enforces UE roaming restrictions. The MIME 654 is the termination point in the network for ciphering/integrity protection for NAS signalling and handles security key management. Further tasks are also put on the MME, and we can here realise the significant amount of signalling and processing load if the associated stations have very intermittent transmission activity.

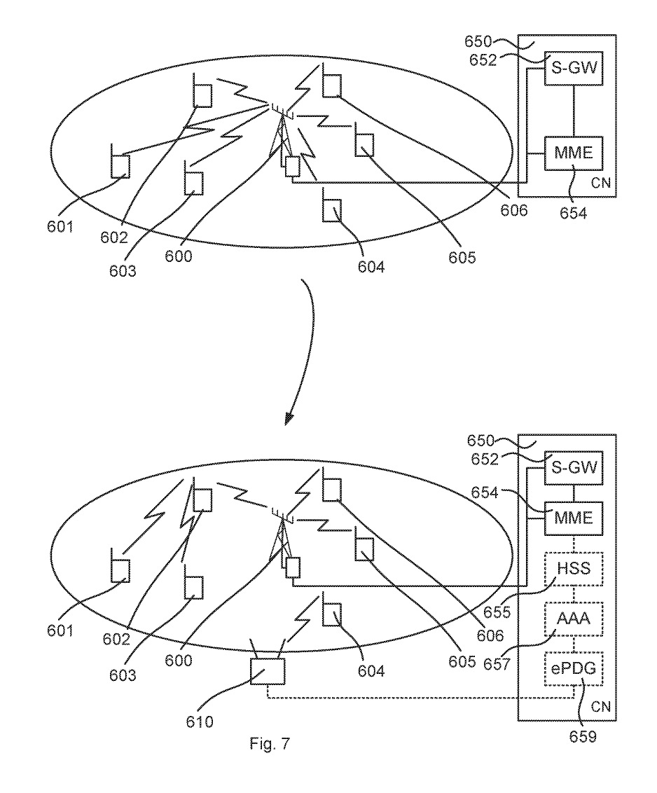

A number of stations 601-606 are associated with the base station 600 and thus with the other connected network nodes 652, 654. Examples on the application of application plans will be demonstrated below with reference to FIG. 7 which is based on the similar cellular communication system as demonstrated with reference to FIG. 6. The same reference numerals are used for the corresponding elements.

FIG. 7 illustrates in its upper part a part of a number of stations 601-606 associated with a base station 600 and network nodes 652, 654 of a core network 650. Transmission behaviour of the stations 601-606 is determined according to any of the embodiments demonstrated above.

According to some embodiments, signalling load of any of the network nodes 600, 652, 654 is determined and upon the load reaching a threshold, also according to any of the embodiments demonstrated above, an action plan is applied for reducing the signalling load on that network node. It is to be noted that different approaches are illustrated in the lower part of FIG. 7, and they may be used simultaneously, but the action plan may also be selected to be one of them.

In the example, it has been found that at least stations 601-604 have intermittent transmission activity indicated by their respective transmission behaviour. According to one action plan or part of an action plan, stations 601-603 have been assisted by the network to apply device-to-device, D2D, communication such that they operate towards the base station 600 as a cluster where communication is routed via station 602. Here, for fair power consumption distribution, the role of being the gateway station or via of the cluster may be changed on regular basis, e.g. periodically, between the stations 601-603 of the cluster. When forming the cluster, the stations verifies whether they are in D2D vicinity, i.e. if they are able to reach each other by direct communication, and then establishes the direct communication and communication by the via or gateway UE to the base station 600 according to D2D principles recognised by the used cellular communication system. By the collection of traffic to the gateway UE or via, the transitions between connected and idle for that station 602 is reasonably reduced, and thus the consumption of network resources. In the example above, all of the stations 601-603 of the cluster were considered to have intermittent transmission activity. However, when forming the cluster, also other stations which do not have intermittent transmission activity may be included in the cluster, e.g. for enabling D2D vicinity.

Consider for example that station 605 also had intermittent transmission activity indicated by its transmission behaviour; but the station 605 was found not to be in D2D vicinity with the stations 601-603, wherein it could not be included in the cluster, and thus remained in normal cellular communication with the base station 600.

In the example, station 604 is within coverage of another radio access system, here illustrated as an access point 610 of a wireless local area network (WLAN), i.e. a non-3GPP radio access technology (RAT). Examples of such non-3GPP accesses may be the WLAN 802.11 family, Bluetooth, 802.15.4 related technologies such as ZigBee, Thread, WirelessHART, ISA100.11a, 6TiSCH, etc. Other examples may be another 3GPP RAT, e.g. using UMTS or GSM. Here, the properties of the other RAT may also be considered when initiating handover such that the other RAT is suitable for the traffic of the station, which is more or less known from the statistics kept. For example, low-bandwidth intermittent transmissions may be suitable for GSM, while high-bandwidth intermittent transmissions may not be suitable for GSM and e.g. WLAN should be a better option. A further example of a part of an action plan is utilizing LIE in an unlicensed spectrum for achieving the performance benefits of LTE also in the unlicensed spectrum. Thus, the station 604 is handed over to the other RAT as part of the action plan, wherein signalling load of the network node is reduced. For the case of handing over to a non-3GPP RAT, the MME 654 may through HSS 655, authentication authorisation and accounting (AAA) functionality 657 and evolved packet data gateway assist setting-up the communication with for example the illustrated WLAN access point 610.

Furthermore, the station 605, as considered above as having intermittent transmission activity but not suitable for being included in D2D communication and may not be in coverage of another suitable RAT, may be subject to another action plan or part of action plan. This may include changing charging to potentially change transmission behaviour; at least temporary, or getting economical coverage for the caused load. In practice, it may include signalling to a charging unit of the cellular communication network that charging should be increased for that station 605. Reasonably, a notification is also transmitted to the subscriber about the charging change. The notification may include a request for accepting the increased charging, and if declined the service may be restricted for that station 605.

As an alternative, the service may be restricted for that station 605, i.e. without the option of continuing with increased charging. For example, the restricted service may include setting lower priority for the intermittent transmissions related to that station 605.

The invention has mainly been described above with reference to a few embodiments. However, as is readily appreciated by a person skilled in the art, other embodiments than the ones disclosed above are equally possible within the scope of the invention, as defined by the appended patent claims.

1. A method of a network node of a cellular communication network, the method comprising:
determining transmission behaviour of stations associated with the network node;
determining whether the transmission behaviour of the station indicates intermittent transmission activity of the station, and
if the intermittent transmission activity indicated by the transmission behaviour of the station is in a first state being an intermittent activity state, applying an action plan for that station such that radio resources allocated to that station are reduced.

2. The method of claim 1, wherein the transmission behaviour comprises any of:
a transition rate between active and idle states of the station;
a number of times entering a discontinuous reception, DRX, state; and
a metric based on an analysis of inflow and outflow of data buffers, which data buffers are arranged for storage of data before transmitting the data to respective stations.

3. The method of claim 1, wherein:
the determining transmission behaviour of the stations comprises registering in a memory each station associated with the network node as either being in the first state or a second state, wherein the first state comprises the transmission behaviour of the station indicating intermittent activity above a second threshold and the second state comprises the transmission behaviour of the station indicating intermittent activity below a third threshold, and
the determining whether the transmission behaviour of the station indicates intermittent activity of the station comprises accessing the memory.

4. The method of claim 1, wherein the second threshold is higher than the third threshold such that a hysteresis is formed.

5. The method of claim 1, wherein the second threshold and the third threshold are equal.

6. The method of claim 1, wherein the action plan for a station comprises any of:
handing over that station to another radio access technology,
operating that station in an unlicensed spectrum using the present radio access technology, and
restricting connection for that station.

7. The method of claim 1, wherein the action plan for a station comprises:
enabling a device-to-device, D2D, communication mode for that station, being a first station;
configuring at least another station, being a set of stations, also being in the first mode for D2D communication mode and verify whether in D2D vicinity to the first station, and if verified as being in D2D vicinity to the first station, configuring connection of the stations of the set of stations by D2D communication via the first station.

8. The method of claim 7, comprising periodically, for the first station and the stations of the set of stations, changing which of the stations to be the first station such that fair power consumption distribution among the stations is achieved.

9. The method of claim 1, wherein the action plan for a station comprises signalling to a charging unit of the cellular communication network to increase charging for that station, and transmitting a notification to that station about the charging change.

10. The method of claim 1, comprising:
determining signalling load of the network node; and
if the signalling load is above a first threshold, enabling the action plan for at least one of the stations associated with the network node and being in the first state.

11. The method of claim 10, wherein the determining the signalling load of the network node comprises determining the used amount of available addresses or memory for keeping track of the associated stations, wherein the first threshold corresponds to a percentage of the used amount to the available addresses or memory.

12. The method according to claim 1, wherein the network node is a node of a core network of the cellular communication network and the determining of transmission behaviour of stations associated with the network node comprises:
receiving, from a base station associated with a station, transmission behaviour of the station associated with a previous time; and
estimating current transmission behaviour of the station, wherein the determining of the transmission behaviour of the station is performed in consideration of the received transmission behaviour and the estimated current transmission behaviour.

13. The method of claim 12, wherein the action plan includes utilizing the determined transmission behaviour for connection or resource management in the network node.

14. The method of claim 1, wherein the network node is a node of a core network of the cellular communication network and the method comprises:
receiving, at a first time instant, transmission behaviour information associated with a station from a base station of the cellular communication network;
storing in a memory the received transmission behaviour information with an identifier associated to the station;
receiving from the base station, at a second time instant, an indication that the station has established a connection with the base station;
retrieving, from the memory, transmission behaviour related to an identifier associated to the station; and
sending the retrieved transmission behaviour information to the base station, such that connection or resource management is facilitated in the base station.

15. A network node of a cellular communication network, the network node comprising:
a transmission behaviour determinator mechanism arranged to determine a transmission behaviour of stations associated with the network node; and
a controller arranged to, for at least one of the stations associated with the network node, determine whether the transmission behaviour of the station indicates intermittent transmission activity of the station, and if the intermittent transmission activity indicated by the transmission behaviour of the station is in a first state being an intermittent activity state, to apply an action plan for that station such that radio resources allocated to that station are reduced.

16. The network node of claim 15, wherein the transmission behaviour comprises any of:
a transition rate between active and idle states of the station;
a number of times entering a discontinuous reception, DRX, state; and
a metric based on an analysis of inflow and outflow of data buffers, which data buffers are arranged for storage of data before transmitting the data to respective stations.

17. The network node of claim 15, wherein:
the transmission behaviour determinator mechanism is arranged to register, in a memory, each station associated with the network node as either being in the first state or a second state, wherein the first state comprises the transmission behaviour of the station indicating intermittent activity above a second threshold and the second state comprises the transmission behaviour of the station indicating intermittent activity below a third threshold, and
the controller is arranged to determine whether the transmission behaviour of the station indicates intermittent activity of the station by accessing the memory.

18. The network node of claim 15, wherein the second threshold is higher than the third threshold such that a hysteresis is formed.

19. The network node of claim 15, wherein the second threshold and the third threshold are equal.

20. The network node of 19 claim 15, wherein to apply the action plan for a station includes that the controller is arranged to perform any of
initiating a hand over of that station to another radio access technology,
initiating operating that station in an unlicensed spectrum using the present radio access technology, and
configuring restriction of connection for that station.

21. The network node of claim 15, wherein the action plan for a station includes that the controller is arranged to:
enable a device-to-device, D2D, communication mode for that station, being a first station;
configure at least another station, being a set of stations, also being in the first mode for D2D communication mode and verify whether in D2D vicinity to the first station, and if verified as being in D2D vicinity to the first station, to configure connection of the stations of the set of stations by D2D communication via the first station.

22. The network node of claim 21, wherein the controller is arranged to periodically, for the first station and the stations of the set of stations, configure change of which of the stations to be the first station such that fair power consumption distribution among the stations is achieved.

23. The network node of claim 15, wherein the action plan for a station includes that the controller is arranged to configure signalling to a charging unit of the cellular communication network about an increase of charging for that station, and to initiate transmission of a notification to that station about the charging change.

24. The network node of claim 15, comprising:
a signalling load determinator mechanism arranged to determine a signalling load of the network node, wherein the controller is arranged to determine whether the signalling load is above a first threshold, and if so, to enable the action plan for at least one of the stations associated with the network node and being in the first state.

25. The network node of claim 24, wherein the signalling load determinator mechanism is arranged to determine the signalling load of the network node by determining the used amount of available addresses or memory for keeping track of the associated stations, wherein the first threshold corresponds to a percentage of the used amount to the available addresses or memory.

26. The network node of claim 15, wherein the network node is a node of a core network of the cellular communication network and the transmission behaviour determinator mechanism is arranged to determine the transmission behaviour of stations associated with the network node by
receiving, from a base station associated with a station, transmission behaviour of the station associated with a previous time; and
estimating current transmission behaviour of the station, wherein the determination of the transmission behaviour of the station is performed in consideration of the received transmission behaviour and the estimated current transmission behaviour.

27. The network node of claim 26, wherein to apply the action plan includes to utilize the determined transmission behaviour for connection or resource management in the network node.

28. The network node of claim 15, wherein the network node is a node of a core network of the cellular communication network and the controller is arranged to
receive, at a first time instant, transmission behaviour information associated with a station from a base station of the cellular communication network;
store in a memory the received transmission behaviour information with an identifier associated to the station;
receive from the base station, at a second time instant, an indication that the station has established a connection with the base station;
retrieve, from the memory, transmission behaviour related to an identifier associated to the station; and
send the retrieved transmission behaviour information to the base station, such that connection or resource management is facilitated in the base station.

29. A nontransitory computer readable storage medium comprising a computer program comprising instructions which, when executed on a processor of a network node of a cellular communication network, causes the network node to perform a method comprising:
determining transmission behaviour of stations associated with the network node;
determining whether the transmission behaviour of the station indicates intermittent transmission activity of the station, and
if the intermittent transmission activity indicated by the transmission behaviour of the station is in a first state being an intermittent activity state, applying an action plan for that station such that radio resources allocated to that station are reduced.
